(19) United States
(12) Patent Application Publication
(10) Pub. No.: US 2026/0237695 A1
(43) Pub. Date: Aug. 13, 2026

(54) EXPANDER FOR A FUEL CELL SYSTEM

(71) Applicants: HYUNDAI MOTOR COMPANY, Seoul (KR); KIA CORPORATION, Seoul (KR)

(72) Inventor: Ji Sang Ryu, Hwaseong-si (KR)

(73) Assignees: HYUNDAI MOTOR COMPANY, Seoul (KR); KIA CORPORATION, Seoul (KR)

(21) Appl. No.: 19/259,234

(22) Filed: Jul. 3, 2025

(30) Foreign Application Priority Data
Feb. 13, 2025 (KR) 10-2025-0018849

(51) Int. Cl. H01M 8/04119

(52) U.S. Cl. CPC H01M 8/04141

(57) ABSTRACT

The present disclosure provides a fuel cell system including: a humidifier having one side connected to a stack to supply droplets toward the stack of the fuel cell system; a gas-liquid separator connected to the other side of the humidifier and configured to separate and discharge air and the droplets in the humidifier, the gas-liquid separator having one side connected to a water discharge port; and an expander connected to the other side of the gas-liquid separator and having a fan configured to rotate to allow the air and the droplets to flow, in which the expander is disposed at a position relatively higher than the gas-liquid separator, such that a rotation direction of the expander for a fuel cell system is specified to prevent produced water from remaining in a volute, thereby preventing corrosion of a product, and preventing the produced water from being introduced into the expander.

### CROSS-REFERENCE TO RELATED APPLICATION

This application claims priority to and the benefit of Korean Patent Application No. 10-2025-0018849, filed in the Korean Intellectual Property Office on Feb. 13, 2025, the entire contents of which are incorporated herein by reference.

### TECHNICAL FIELD

The present disclosure relates to an expander for a fuel cell system, and more particularly, to an expander for a fuel cell system, in which a rotation direction of the expander for a fuel cell system is specified to prevent produced water from remaining in a volute.

### BACKGROUND

A fuel cell system refers to a system that continuously produces electrical energy by means of a chemical reaction of continuously supplied fuel. Research and development are consistently being performed on fuel cell systems as an alternative capable of solving global environmental issues.

Based on types of electrolytes used for fuel cell systems, a fuel cell system may be classified into a phosphoric acid fuel cell (PAFC), a molten carbonate fuel cell (MCFC), a solid oxide fuel cell (SOFC), a polymer electrolyte membrane fuel cell (PEMFC), an alkaline fuel cell (AFC), a direct methanol fuel cell (DMFC), and the like. Based on operating temperatures, output ranges, and the like as well as types of used fuel, the fuel cell systems may be applied to various application fields related to mobile power, transportation, distributed power generation, and the like.

Among the fuel cells, the polymer electrolyte membrane fuel cell is applied to the field of a hydrogen vehicle (hydrogen fuel cell vehicle) being developed to substitute for an internal combustion engine.

A hydrogen electric vehicle is configured to produce electricity by means of a chemical reaction between hydrogen and oxygen and to travel by driving a motor. More specifically, the hydrogen electric vehicle may include a hydrogen tank configured to store hydrogen (H₂), a fuel cell stack configured to produce electricity by means of an oxidation-reduction reaction between hydrogen and oxygen (O₂), a battery configured to store the electricity produced by the fuel cell stack, a controller configured to convert and control the produced electricity, and a motor configured to generate driving power.

An electrolyte membrane of a membrane electrode assembly needs to be maintained at a predetermined humidity or higher in order to normally operate the fuel cell stack, and thus inflow gas introduced into the fuel cell stack may be humidified by a humidifier before being introduced into the fuel cell stack.

However, there is a problem in that when an excessively humidified inflow gas or an inflow gas containing droplets (condensate water droplets) is consistently supplied to the fuel cell stack, flooding occurs in the fuel cell stack, which causes deteriorations in performance and operational efficiency of the fuel cell stack.

Therefore, recently, various studies have been conducted to effectively capture droplets from the inflow gas introduced into the fuel cell stack, but the study result is still insufficient. Accordingly, there is a need to develop a technology to effectively capture droplets from the inflow gas introduced into the fuel cell stack.

In order to supply the droplets toward the stack of the fuel cell system, the fuel cell system includes a humidifier having one side connected to the stack, a gas-liquid separator connected to the other side of the humidifier, configured to separate and discharge air and droplets in the humidifier, and having one side connected to a water discharge port, and an expander connected to the other side of the gas-liquid separator and having a fan configured to rotate to allow the air and the droplets to flow.

When the expander (turbine) rotates at a high speed, produced water introduced into an inlet may be smoothly discharged to an outlet. However, when the expander (turbine) rotates at a low speed, the produced water is somewhat difficult to discharge.

In addition, there is a problem in that in a situation in which the system is stopped within a short period of time even though the expander rotates at a high speed, the produced water may remain in the system without being completely discharged to the outlet.

The reason why the produced water remains is because of the unique geometric features of an expander volute. Because a flow path shape in the expander volute has a space formed below an outlet port so that water stagnates in the space, there is a problem in that the produced water inevitably always remains in the expander volute, and the expander cannot effectively operate.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to provide an expander for a fuel cell system, in which a rotation direction of the expander for a fuel cell system is specified to prevent produced water from remaining in a volute, thereby preventing corrosion of a product, preventing the produced water from being introduced into the expander, and consistently maintaining a state in which the expander may operate smoothly.

In order to achieve the above-mentioned object, the present disclosure provides a fuel cell system including a humidifier having one side connected to a stack to supply droplets toward the stack of the fuel cell system, a gas-liquid separator connected to the other side of the humidifier, configured to separate and discharge air and the droplets in the humidifier, and having one side connected to a water discharge port, and an expander connected to the other side of the gas-liquid separator and having a fan configured to rotate to allow the air and the droplets to flow, in which the expander is disposed at a position relatively higher than the gas-liquid separator.

In this case, the expander may further include: a connection port configured to connect the expander and the gas-liquid separator, in which the connection port is disposed and configured to be inclined upward with respect to the gas-liquid separator, and in which the expander is connected to an end of the connection port.

Further, the fan may rotate in a direction in which the fan prevents produced water from remaining in the expander.

In addition, the expander may further include: a heater provided on an outer surface of the water discharge port and configured to prevent the water discharge port from being frozen in cold temperatures, such as the winter season.

Further, the expander may further include: an air pressure adjustment valve configured to adjust pressure of air generated by the expander, in which the air pressure adjustment valve is installed in the connection port disposed and configured to be inclined with respect to the gas-liquid separator.

Further, the water discharge port may be disposed and configured to be inclined downward at one side of the gas-liquid separator.

In addition, the connection port may be disposed and configured to be inclined with respect to a horizontal plane so as to have a relatively larger inclination angle than the water discharge port.

As described above, in the expander for a fuel cell system according to an embodiment of the present disclosure, the rotation direction of the expander for a fuel cell system is specified, such that the produced water may be prevented from remaining in the volute, thereby preventing corrosion of the product.

Further, the produced water, which is produced while the fuel cell system operates, may be prevented from being introduced into the expander, and the state in which the expander may operate smoothly may be consistently maintained, thereby improving the operational efficiency of the expander.

### BRIEF DESCRIPTION OF THE DRAWINGS

FIG. 1 is an exploded perspective view illustrating a state in which a structure of a fuel cell system according to an embodiment of the present disclosure is disassembled.

FIG. 2 is a top plan view illustrating the structure of the fuel cell system according to an embodiment of the present disclosure.

FIG. 3 is a top plan view illustrating a structure in which a heater is installed in a water discharge port of the fuel cell system according to an embodiment of the present disclosure.

### DETAILED DESCRIPTION

Hereinafter, an expander for a fuel cell system according to an embodiment of the present disclosure is described in more detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by a person with ordinary skill in the art to which the present disclosure pertains. The meanings of the commonly used terms such as the terms defined in dictionaries may be interpreted in consideration of the contextual meanings of the related technology.

In addition, the terms used to describe the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function.

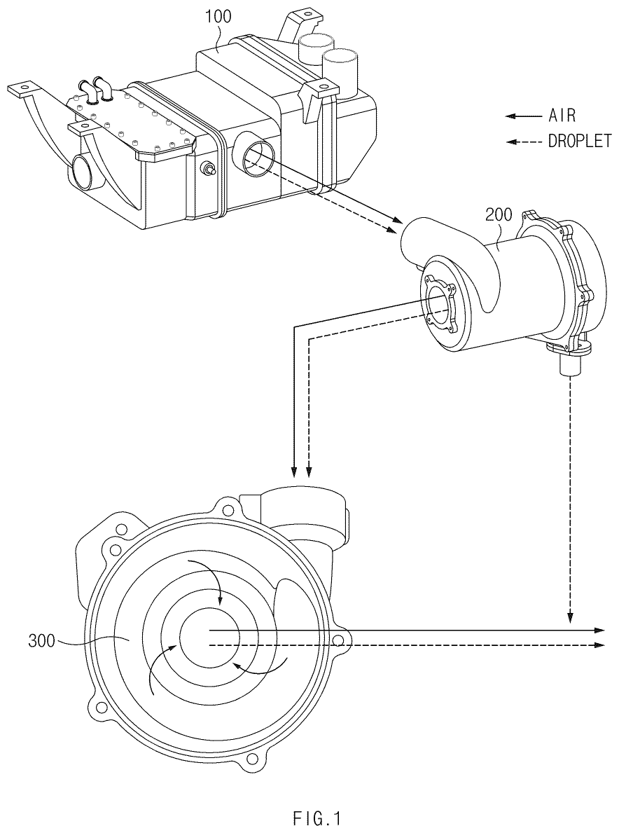

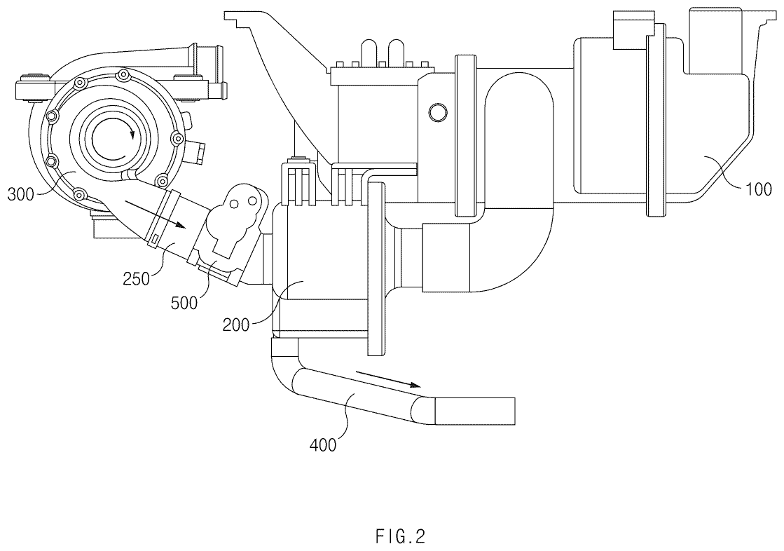

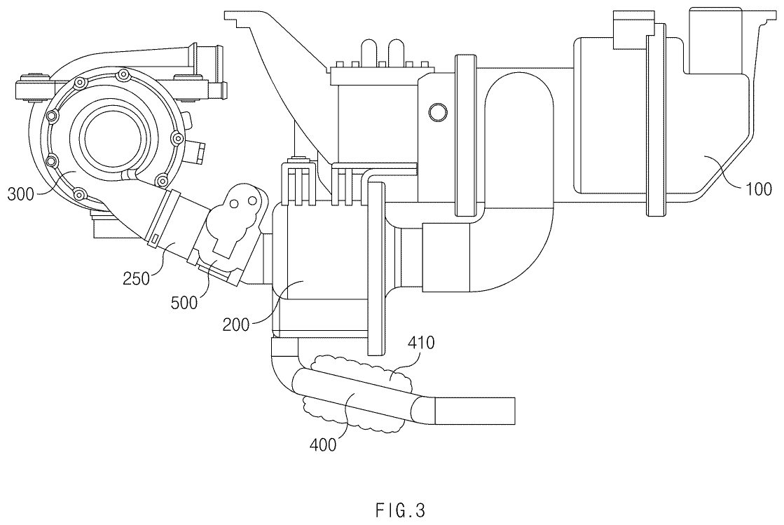

FIG. 1 is an exploded perspective view illustrating a state in which a structure of a fuel cell system according to an embodiment of the present disclosure is disassembled. FIG. 2 is a top plan view illustrating the structure of the fuel cell system according to an embodiment of the present disclosure. FIG. 3 is a top plan view illustrating a structure in which a heater is installed in a water discharge port of the fuel cell system according to an embodiment of the present disclosure.

As illustrated in these drawings, a fuel cell system according to an embodiment of the present disclosure is a fuel cell system including a humidifier 100 having one side (a first side) connected to a stack (not illustrated) to supply droplets toward the stack of the fuel cell system and a gas-liquid separator 200 connected to the other side (a second side) of the humidifier 100, the gas-liquid separator 200 being configured to separate and discharge air and the droplets in the humidifier 100, and having one side (a first side) connected to a water discharge port 400. The fuel cell system also includes an expander 300 connected to the other side (a second side) of the gas-liquid separator 200 and having a fan configured to rotate to allow the air and the droplets to flow. The expander 300 is disposed at a position relatively higher than the gas-liquid separator 200, with respect to a horizontal plane.

The humidifier 100 serves to supply a predetermined amount of droplets toward the stack of the fuel cell system. To this end, one side of the humidifier 100 is connected to the stack, and the other side of the humidifier 100 is connected to the gas-liquid separator 200 configured to remove the droplets contained in the discharged gas.

The gas-liquid separator 200 serves to remove the droplets, which are contained in exhaust gas that has been completely used in the fuel cell system, and then discharge the droplets to the outside, thereby preventing the fan, which is installed in the expander 300 connected to one side of the gas-liquid separator 200 and rotates at a high speed, from being damaged by the droplets.

To this end, one side of the gas-liquid separator 200 is connected to the humidifier 100, and the other side of the gas-liquid separator 200 is connected to the water discharge port 400, such that the collected droplets may be discharged to the outside through the water discharge port 400.

Further, it is effective that the gas-liquid separator 200 is disposed at a position relatively lower than the humidifier 100 (with respect to a horizontal plane), such that the produced water remaining in the humidifier 100 may be allowed to flow toward the gas-liquid separator 200 by gravity, and the produced water collected in the gas-liquid separator 200 may be discharged to the outside of the system or vehicle along the water discharge port 400.

The expander 300 refers to a member connected to the other side of the gas-liquid separator 200 and having the fan configured to rotate to allow the air and the droplets to flow. As described above, it is effective that the expander 300 may be disposed at a position relatively higher than the gas-liquid separator 200.

Because the expander 300 is disposed at a position relatively higher than the gas-liquid separator 200, the produced water made by the collected droplets does not remain in the expander 300, such that an optimal state in which the expander 300 may always operate efficiently may be maintained.

In other words, because the expander 300 is disposed at a position relatively higher than the gas-liquid separator 200, the produced water may be naturally moved toward the gas-liquid separator 200 and discharged by gravity without remaining in the expander 300.

Further, a connection port 250 is installed between the expander 300 and the gas-liquid separator 200 and connects the expander 300 and the gas-liquid separator 200. The connection port 250 may be disposed to be inclined upward with respect to the gas-liquid separator 200 (i.e., with respect to a longitudinal axis of the gas-liquid separator 200), and the expander 300 may be connected to an end of the connection port 250.

A degree to which the connection port 250 is disposed to be inclined upward is calculated on the basis of an inclination angle of a road. It is effective that a specific angle may be set in accordance with a direction in which the fuel cell system is disposed in the vehicle.

The fan configured to rotate is provided in the expander 300. The fan may rotate in a direction in which the fan may prevent the produced water from remaining in the expander 300.

In an embodiment of the present disclosure, as illustrated in FIG. 2, the fan in the expander 300 rotates clockwise so that the produced water does not remain in the expander 300.

Further, as shown in FIG. 3, a heater 410 may be installed on an outer surface of the water discharge port 400 to prevent the water discharge port 400 from being frozen in cold temperatures, such as the winter season. Even in the winter season with a low outside atmospheric temperature, the water is smoothly discharged, such that the expander 300 may consistently operate under an optimal environment.

In addition, the fuel cell system may further include an air pressure adjustment valve 500 capable of adjusting pressure of air generated by the expander 300. The air pressure adjustment valve 500 may be installed in the connection port 250 and be disposed to be inclined with respect to the gas-liquid separator 200 (i.e., inclined upward with respect to a longitudinal axis of the gas-liquid separator 200).

Because the air pressure adjustment valve 500 is installed in the connection port 250 disposed to be inclined, it is possible to prevent the produced water from being introduced into the air pressure adjustment valve 500 or prevent the produced water from remaining in the air pressure adjustment valve 500.

The air pressure adjustment valve 500 may be installed in the connection port 250 installed between the gas-liquid separator 200 and the expander 300. However, the air pressure adjustment valve 500 may be installed between the humidifier 100 and the gas-liquid separator 200 under a condition in which the produced water is not introduced into the air pressure adjustment valve 500.

Further, it is effective that the water discharge port 400 may be disposed to be inclined downward at one side of the gas-liquid separator 200 in order to quickly discharge water. The connection port 250 may be disposed to be inclined with respect to a horizontal plane so as to have a relatively larger inclination angle than the water discharge port 400, which may accurately prevent the produced water from remaining in the expander 300.

The expander for a fuel cell system according to the present disclosure configured as described above may implement the primary high-pressure sealing by using the pressure applied by the stored fluid and implement the secondary sealing by generating constant pressure in the low-pressure region that may be formed by a leak of the fluid while the pressure is released, thereby ensuring the structure of the boss with excellent sealability.

While the embodiments, which may be implemented by the present disclosure, have been described above, the embodiments are just illustrative and not intended to limit the present disclosure. It can be appreciated by those having ordinary skill in the art that various modifications and applications, which are not described above, may be made to the present embodiments without departing from the intrinsic features of the present embodiments. For example, the respective constituent elements specifically described in the embodiments may be modified and then carried out. Further, it should be interpreted that the differences related to the modifications and applications are included in the scope of the present disclosure defined by the appended claims.

What is claimed is:

1. A fuel cell system comprising:
a humidifier having a first side connected to a stack to supply droplets toward the stack of the fuel cell system;
a gas-liquid separator connected to a second side of the humidifier and configured to separate and discharge air and the droplets in the humidifier, the gas-liquid separator having one side connected to a water discharge port; and
an expander connected to another side of the gas-liquid separator and having a fan configured to rotate to allow the air and the droplets to flow,
wherein the expander is disposed at a position higher than the gas-liquid separator.

2. The fuel cell system of claim 1, further comprising:
a connection port configured to connect the expander and the gas-liquid separator,
wherein the connection port is inclined upward with respect to the gas-liquid separator, and
wherein the expander is connected to an end of the connection port.

3. The fuel cell system of claim 1, wherein the fan is configured to rotate in a direction in which the fan prevents produced water from remaining in the expander.

4. The fuel cell system of claim 1, further comprising:
a heater provided on an outer surface of the water discharge port and configured to prevent the water discharge port from being frozen in cold weather.

5. The fuel cell system of claim 2, further comprising:
an air pressure adjustment valve configured to adjust pressure of air generated by the expander,
wherein the air pressure adjustment valve is disposed in the connection port and inclined with respect to the gas-liquid separator.

6. The fuel cell system of claim 1, further comprising an air pressure adjustment valve disposed between the humidifier and the gas-liquid separator.

7. The fuel cell system of claim 1, wherein the water discharge port is inclined downward at one side of the gas-liquid separator.

8. The fuel cell system of claim 7, wherein the connection port is inclined with respect to a horizontal plane so as to have a larger inclination angle than the water discharge port.

9. The fuel cell system of claim 2, wherein a degree to which the connection port is inclined upward is calculated based on an inclination angle of a road.

10. The fuel cell system of claim 2, wherein an inclination angle of the connection port is based on a direction in which the fuel cell system is disposed in a vehicle.

11. The fuel cell system of claim 1, wherein the gas-liquid separator is disposed at a position lower than the humidifier, such that produced water in the humidifier flows toward the gas-liquid separator by gravity, and the produced water collected in the gas-liquid separator is discharged to outside the fuel cell system or vehicle along the water discharge port.
